(19) United States
(12) Patent Application Publication
(10) Pub. No.: US 2018/0292733 A1
(43) Pub. Date: Oct. 11, 2018

(54) Plot Pod

(71) Applicant: John Marcus Emfinger, Bentonia, MS (US)

(72) Inventor: John Marcus Emfinger, Bentonia, MS (US)

(73) Assignee: John Marcus Emfinger, Bentonia, MS (US)

(21) Appl. No.: 15/480,369

(22) Filed: Apr. 6, 2017

(51) Int. Cl. G03B 17/56; F16M 11/36; F16M 11/04; F16M 11/10

(52) U.S. Cl. CPC G03B 17/561; F16M 11/36; F16M 2200/028; F16M 11/10; F16M 11/046

(57) ABSTRACT

The invention provides a light-weight trail camera tripod, comprising a center mast for supporting and securing a mount for a photographic device, provided with three hinged members, three telescoping legs, each leg comprising at least on interconnected telescopic joint with an associated compression-resistant interlocking unit, and further comprising an attachable and detachable foot assembly and interlocking apparatus thereby each leg can be engaged and disengaged enabling the shortening and lengthening of the assembly and secured to said foot assembly.

### REFERENCE TO RELATED APPLICATION

This patent application is a regular patent application claiming priority to U.S. Provisional Patent Application Ser. No. 62/319,251, filed on Apr. 6, 2016.

### FEDERALLY SPONSORED RESEARCH

N/A

### SEQUENCE LISTING OR PROGRAM

N/A

### BACKGROUND OF THE INVENTION

The present invention related to wildlife photography in the field with the use of trail cameras and such.

Trail cameras used in the field are typically attached to an existing tree or post for the purpose of wildlife and other game photography. However, sometimes it is desirable to place the trail camera in a food plot or in a grassy area where the typical attachment structure is not always available.

### SUMMARY OF THE INVENTION

Disclosed herein is an apparatus for attaching a trail camera that allows the camera to be easily and quickly deployed and moved in areas where mounting structures are not available. It also offers the availability of an L-Shaped Adapter Plate for trail cameras not offering a mounting option within the camera itself. It is comprised of three telescoping legs, a center mast, and threaded attachment bolt which are all fully adjustable.

### DESCRIPTION OF THE SEVERAL VIEWS OF THE DRAWINGS

FIG. 1 is a front view illustrating the general configuration of the adjustable plot pod discussed herein.

FIG. 2 is a front view of the L-Shaped adapter plate for cameras that do not have an installed mounting nut.

FIG. 3 is a side view of the L-Shaped Adapter Plate with the mounting nut shown.

FIG. 4 is an exploded view of the center mast and the mounting screw.

FIG. 5 is an exploded view of the foot assembly of the Plot Pod for illustrating the anchor hole and the attaching screw of each foot assembly.

### DETAILED DESCRIPTION OF THE INVENTION

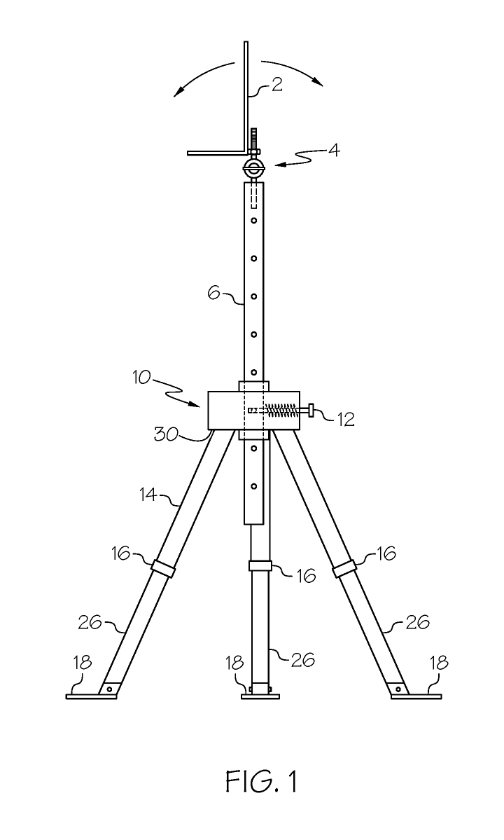

Referring now to the invention in more detail, in FIG. 1 is illustrated the general configuration of the Plot Pod comprises three identical telescoping legs each comprising a foot assembly 18, a lower leg 25, and an upper leg 14 being pivotally connected by a pivot connector 30 to a center platform 10 through which a center mast 6 centrally protrudes having a rotating and pivoting threaded attachment mechanism 4 and an L-Shaped adapter plate 2 attached to the upper end and is adjustable in height using a spring loaded pin 12 inserted into adjustment holes 8 along the center mast 6.

The lower leg 26 fits fully into the upper leg 14 and is adjustable in length by an interlocking device 16 located at the lower end of the upper leg 14. As best seen in FIG. 5, located at the lower end of each lower leg attached with a screw for adjustability and security is a foot assembly 18. Each foot assembly has a hole 28 located in the center near the outer edge for anchoring each leg if desired.

Referring to FIG. 1 to best illustrate the use and usefulness of the center mast 6 that centrally protrudes through the center platform 10. As best seen in FIG. 4, this mast has adjustment holes 8 along its length to provide the appropriate height for the application. Located at the upper end of the center mast 6 is a rotating and pivoting threaded attachment mechanism 4 with an adjustment device 24. By loosening a threaded compression apparatus 24, the rotating and pivoting threaded attachment mechanism 4 can adjusted to the desired angle for the camera or L-Shaped adapter plate 2.

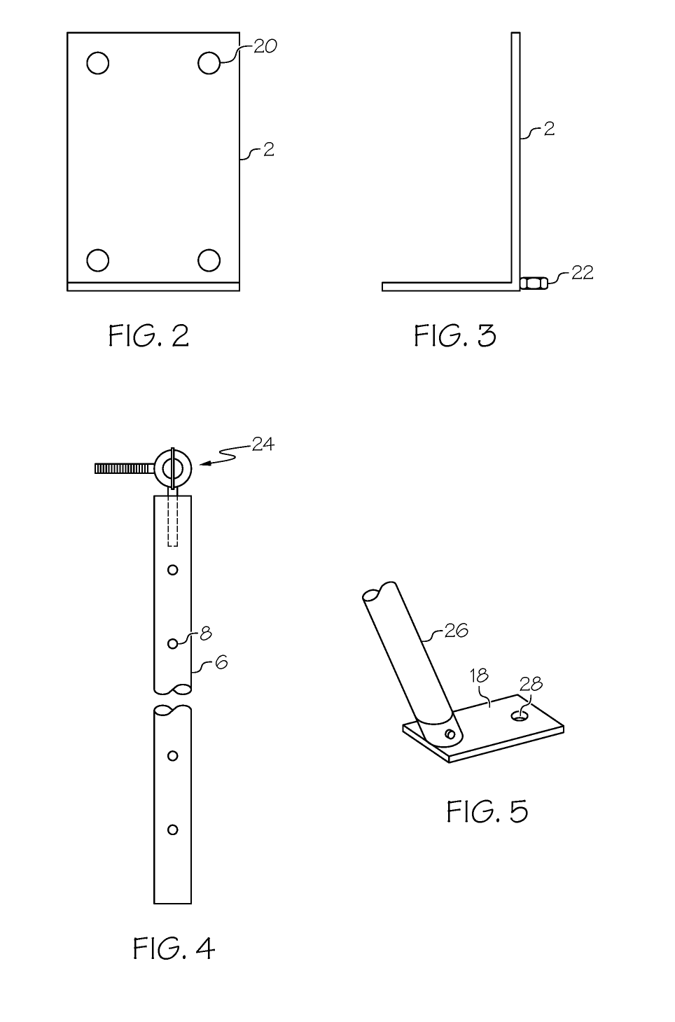

The L-Shaped adapter plate 2 as seen in FIG. 1 can be attached to the rotating and pivoting threaded attachment mechanism 4 by a threaded nut 22 located at the bottom rear of the L-Shaped adapter plate as best seen in the exploded view in FIG. 3. Located near each corner of the L-Shaped adapter plate 2, referring to FIG. 2, are small holes 20 through which the camera can be secured. As also seen in FIG. 3, the L-Shaped adapter plate has a shelf for the camera to rest while in use.

1. A light-weight trail camera tripod comprising
a) An L-Shaped Adapter Plate for securing a photographic device to a center mast comprising:
1) a pair of plates wherein the second plate is aligned and attached perpendicular to the lower portion of the first plate;
2) a threaded nut is attached to the L-Shaped Adapter Plate on the lower portion of the mount for connection purposes:
b) a rotating and pivoting threaded attachment mechanism for attaching above mentioned L-Shaped Adapter Plate comprising:
1) a pair of circular plates with a threaded stem protruding from each;
2) a threaded compression apparatus going through the above mentioned circular plates for securing together to form the correct angle and direction:
c) a center mast for supporting said above mentioned L-Shaped Adapter Plate comprising:
1) an elongated pipe having a first end solid and a second end with a threaded cap for accepting the above-mentioned rotating and pivoting threaded attachment mechanism thus making it capable of rotating and pivoting on said axis:
2) holes drilled through the center mast for additional support while in use;
d) a center platform wherein said center mast protrudes through comprising:
1) at least three hinge members wherein the legs are each attached;
2) a compression apparatus wherein when engaged said center mast is secured and supported in place:
3) a spring loaded pin mechanism wherein when inserted into above-mentioned holes in center mast provides additional security and support;
e) at least three telescoping legs each attached to one of said hinge members, wherein each leg comprises an upper and a lower section interconnected by compression-resistant interlocking units:
f) a foot assembly positioned at the lower end of each lower leg wherein the foot assembly is attachable and detachable to the lower portion of the lower leg by a locking screw.

2. A tripod according to claim 1 wherein each said foot assembly is secured to the ground plane which a sharp point on one end and an opposite, second end having an enlarged or curved shape head.

3. A tripod according to claim 1 wherein the legs of the foldable hinged members are telescopically extendable, operation of each joint being controlled by a compression-resistant interlocking unit.
